(19) United States
(12) Patent Application Publication
(10) Pub. No.: US 2004/0173440 A1
(43) Pub. Date: Sep. 9, 2004

(54) Measurement and detection roller

(76) Inventors: Harald Mauch, Munchen (DE); Gerhard Schmidt, Grafenberg (DE); Johann Stromer, Ernsbach (DE)

Correspondence Address: HARNESS, DICKEY & PIERCE, P.L.C., P.O.BOX 8910, RESTON, VA, 20195, US

(21) Appl. No.: 10/479,830

(22) PCT Filed: May 23, 2002
(86) PCT No.: PCT/DE02/01898

(30) Foreign Application Priority Data
Jun. 5, 2001 (DE) 101 27 129.8
Jun. 27, 2001 (DE) 101 31 019.6

(51) Int. Cl. B65G 13/06

(52) U.S. Cl. 198/781.05

(57) ABSTRACT

A roller, especially for roller conveyors of transport and/or logic systems, includes an integrated sensor system. The roller can be embodied as a passive roller and/or as a drive roller. The roller can also be provided with an integrated drive system and/or integrated information processing units. A positive fit between the roller and a support structure is provided by at least one polygonal profiled section on the end of the roller. Contacts to the lines for the power supply and the data bus are advantageously produced with penetration clips.

The invention relates to a roller for a roller conveyor, especially for transport and/or logistics systems.

A roller conveyor of this type is used for example for conveying items or parts from one station to a further station.

In the application DE 19959536.4, which is not a prior publication, it has been proposed to integrate a drive and information-processing units into rollers for logistics systems.

It is known from DE 199 12 391 A1 to use a light barrier as a sensor for controlling roller conveyors. Such external sensors must however be laboriously mounted and set and they are also not “vandalproof”.

Various types of sensors are described in “Sensoren in der Automatisierungstechnik” [Sensors in automation engineering], G. Schnell (editor), published by Vieweg & Sohn, 1991.

The object of the invention is to form rollers for roller conveyors of the type stated at the beginning in such a way that the detection of conveyed items and the measurement of transporting distances is performed in a very simple and efficient manner. In this connection it should be mentioned that, apart from the drive rollers, it is quite possible for there to be in a roller conveyor a certain number of non-driven rollers. Furthermore, it is also possible for the movement of electrically driven drive rollers to be transferred to powerless rollers via coupling elements. The object stated above is achieved by the invention for rollers of the type stated at the beginning by the rollers comprising an integrated sensor system. In the case of these rollers, the sensor system is protected against external mechanical influences and it does not have to be separately mounted externally. A further advantage lies in the freedom from maintenance of such systems; an adjustment of the sensor system is no longer necessary. The wiring goes through bores in the roller axes. The wiring may be performed for example by means of a bus system with a “clip technique”. The integrated sensor system may be fitted both in passive rollers and in drive rollers (rollers with a drive unit).

A first advantageous form of the invention is characterized in that the integrated sensor system comprises at least one inductive sensor. This configuration is of advantage in particular for the detection of metallic conveyed items. Inductive individual sensors and/or inductive area sensors are fitted inside the roller. The material of the roller may be plastic or metal. The inductive sensors are in this case mounted in such a way that their electromagnetic detection field is aligned in the direction of the conveyed item. By suitable selection of inductive sensors and by suitable installation of the inductive sensors (possibly with a copper shielding), blanking out of the metallic conveying roller is possible. If a metallic conveyed item then moves over the roller, detuning of the electromagnetic field takes place. In this case, the sensor detects the presence of a conveyed item and reports this at its switching output. A further advantage of inductive sensors is that they operate in a contactless and isolated manner and have a long service life together with high reliability.

A further advantageous form of the invention is characterized in that the integrated sensor system comprises at least one capacitive sensor. This configuration is of advantage in particular for rollers made of plastic. Capacitive individual sensors and/or capacitive area sensors are

fitted inside the roller. The material of the roller should be plastic. The capacitive sensors are in this case mounted in such a way that their electrical detection field is aligned in the direction of the conveyed item. The capacitive sensors are aligned in such a way that rollers made of plastic are blanked out. If a conveyed item then moves over the roller, detuning of the electrical field takes place. In this case, the sensor detects the presence of a conveyed item and reports this at its switching output. In the same way as inductive sensors, capacitive sensors operate in a contactless and isolated manner. Capacitive sensors can also detect non-conducting materials.

A further advantageous form of the invention is characterized in that the integrated sensor system comprises at least one optical sensor. If an optical sensor (for example a reflection light sensor or a reflection light barrier) is integrated into the roller, external interfering influences can be effectively suppressed. Therefore, in the case of this configuration it is possible to dispense almost entirely with devices for interference suppression.

A further advantageous form of the invention is characterized in that the integrated sensor system comprises at least one vibration sensor and/or at least one piezo sensor. Such rollers are suitable for many different types of conveyed items. When vibration sensors are used, the roller is made to vibrate slightly from inside by a mechanical oscillation generator. This vibration is measured by a suitable sensor system. The mechanical oscillation generator is in this case not hard-coupled to the roller. If a conveyed item is on the roller, the mechanical oscillation is changed by the damping caused by it. This is measured and evaluated by the sensor system.

The oscillation of the roller may also be generated by external mechanical and/or electrodynamic and/or magnetic elements. Piezo sensors respond to pressure; they may

be formed as a membrane sensor or as a crystal sensor. In the case of crystal sensors, quartz crystals are usually used (if a quartz crystal is subjected to a pressure, charge transfers are produced on the side faces of the crystal as a measure of the pressure, and are then measured. Piezo sensors detect conveyed items which are on the roller conveyor by the piezo principle.

A further advantageous form of the invention is characterized in that the integrated sensor system comprises at least one microwave transmitter and/or at least one radar transmitter. If the microwave transmitter or the radar transmitter is integrated in the roller, they are not exposed to any external interfering influences (for example mechanical effects).

A further advantageous form of the invention is characterized in that the roller has an integrated drive, which can be connected to an electrical energy supply. By this type of design, space is saved and the drive is protected from mechanical disturbances.

A further advantageous form of the invention is characterized in that the roller has an integrated information-processing unit and in that the latter can be connected via a central data bus, which also has connection possibilities for a multiplicity of further units, separate lines being provided for the energy supply and the data bus. It is consequently ensured on the one hand that this unit is protected from environmental influences, on the other hand a compact type of design of the overall arrangement is ensured. Furthermore, the invention makes it possible to connect not only additional drive rollers but also further units (for example actuators) to the central data bus and to integrate them in the overall system in a simple way. The robustness of the overall system is increased by the separate lines respectively for the energy supply and the data bus.

An exemplary embodiment of the invention is explained in more detail below and represented in the drawing, in which:

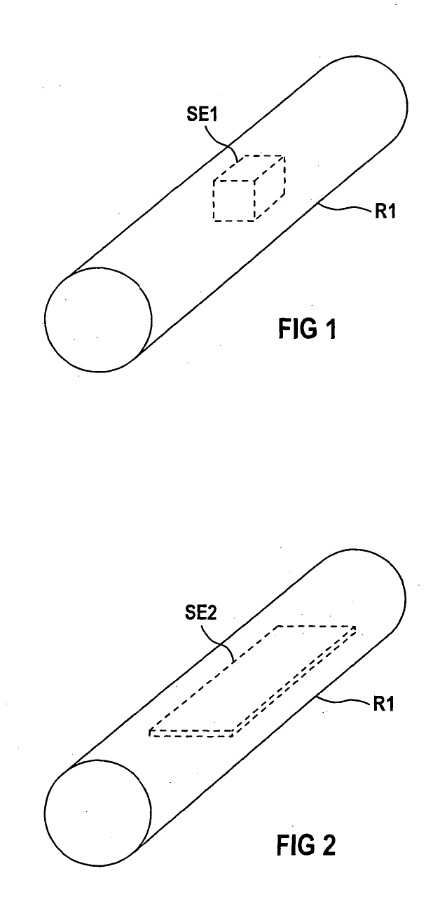

FIG. 1 shows a roller with an integrated sensor element,

FIG. 2 shows a roller with an integrated flat sensor element,

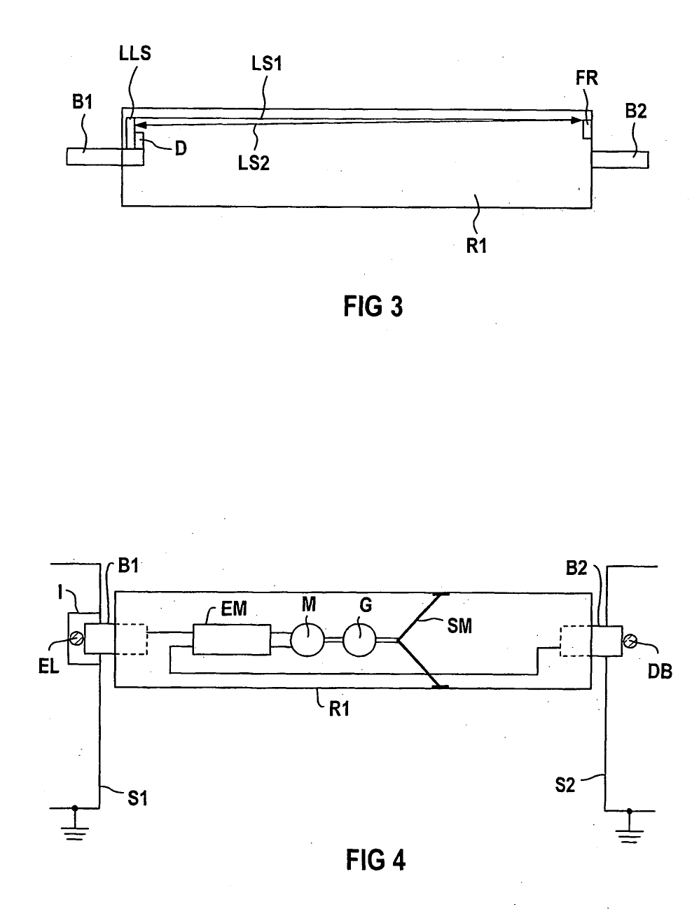

FIG. 3 shows a roller with an integrated optical sensor system,

FIG. 4 shows details of a roller with an integrated information-processing unit and an integrated drive, and also of the energy supply,

FIG. 5 shows details of the positive mechanical fit between the roller and the support structure, and

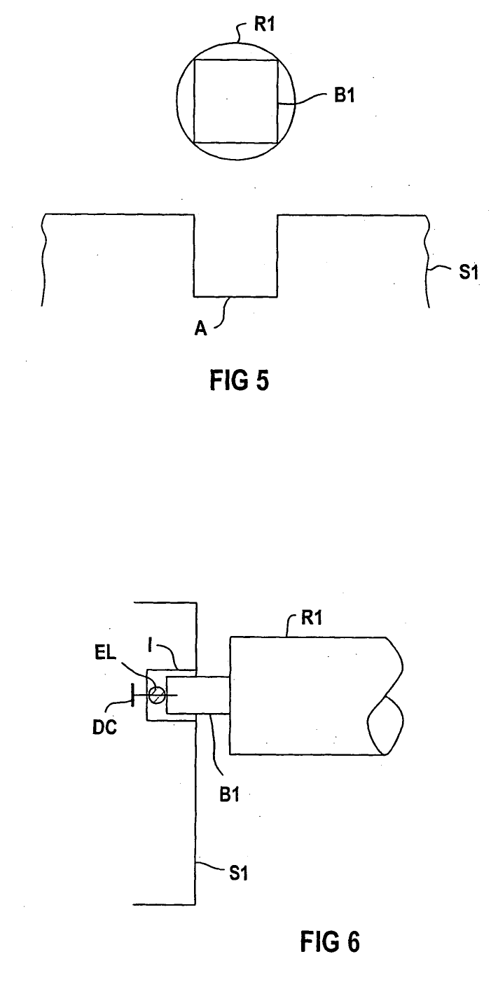

FIG. 6 shows details of the way in which contact is established between the energy supply and the roller.

The representation according to FIG. 1 shows a roller R1 with an integrated sensor element SE1. The sensor element SE1 is located inside the roller R1 and is schematically represented as a cuboid. A number of sensor elements, even different ones, may be located in one roller. A roller may in this case be formed as a passive roller or as a drive roller (roller with integrated or external drive). For reasons of overall clarity, the fastening means, which ensure stable retention of the sensor elements, are not represented in the representation according to FIG. 1. It is conceivable for the sensor elements SE1 to be fastened on the fastening parts (B1, B2; FIG. 4) or on the roller R1, for example by a clamping device or by a spreading mechanism (SM; FIG. 4), as described in FIG. 4.

The side profile of the conveying system or the side guidance should be configured in such a way that the holder for the sensor system can be fastened without any great effort.

The sensor elements SE1 of the roller according to the invention may be of different types: inductive sensors, capacitive sensors, optical sensors, photosensors, magnetic field sensors, temperature sensors, weight sensors, deformation sensors, pressure sensors, etc.

The representation according to FIG. 2 shows a roller R1 with an integrated sensor element SE2. The sensor element SE2 is formed as an area sensor. The sensor element SE2 is located inside the roller R1 and is schematically represented as a flat plate. A number of sensor elements, even different ones, may be located in one roller. A roller may in this case be formed as a passive roller or as a drive roller (roller with integrated or external drive). For reasons of overall clarity, the fastening means, which ensure stable retention of the sensor elements, are not represented in the representation according to FIG. 2. It is conceivable for the sensor elements SE2 to be fastened on the fastening parts (B1, B2; FIG. 4) or on the roller R1, for example by a clamping device or by a spreading mechanism (SM; FIG. 4), as described in FIG. 4.

The sensor elements SE2 of the roller according to the invention may be of different types: inductive sensors, capacitive sensors, optical sensors, photosensors, magnetic field sensors, temperature sensors, weight sensors, deformation sensors, pressure sensors, etc. Furthermore, it is pointed out that sensor elements of different types and different forms may be located in one roller. Further units, for example information-processing units (EM; FIG. 4), may also be located in a roller.

The representation according to FIG. 3 shows a roller R1 with an integrated optical sensor system. In the present configuration, the optical sensor with a light-guiding system LLS and a transmitting and receiving diode D is fastened on a fastening element (B1, B2; FIG. 4) of the roller R1. The optical sensor is in this case fastened in the cavity of the roller R1 in such a way that it is fixed in place. The housing of the roller rotates around it. A foil reflector FR, which picks up the light beam LS1 of the light-guiding system LLS and reflects it back to the light-guiding system LLS by the light beam LS2, has been applied on one of the end sides inside the roller. The optical signals of the light beam LS2 received at the light-guiding system LLS can be used to generate an electronic output signals, which are passed directly or via a bus interface (e.g. AS-I bus) to a controller. It is also conceivable to evaluate or pre-evaluate the optical signals by an information-processing unit (EM; FIG. 4) integrated into the roller and then send corresponding electrical signals to the controller.

The optical sensor system integrated in the roller may be realized for example as a reflection light sensor, as a reflection light barrier or as a transmitted-light barrier. Different methods of suppressing interfering influences may also be used, for example interference suppression by digital filtering, interference suppression by blanking, interference suppression by bandpass filtering or the use of polarization filters. Different technologies can also be used in the case of the diodes, e.g. PN diodes, PIN diodes, PSD diodes (position sensitive detector), or LED diodes and IRED diodes.

Shown in the representation according to FIG. 4 is a roller R1 of a roller conveyor, the further rollers of which may be arranged staggered depthwise behind the roller R1. These and the further rollers are fixed in stand elements S1 and S2 of a support structure. The roller R1 according to the representation in FIG. 4 is an active roller, which has a motor M, which sets the casing of the roller

R1 in rotation via a gear mechanism G and a spreading mechanism SM. For this purpose, the motor M is supplied with power via an information-processing unit in the form of an electronic module EM, the energy flow for this purpose being achieved in a bipolar manner via fastening part B1. The fastening part B1 is in this case electrically contacted with respect to the energy line EL, which is provided for example with an insulating part I. The fastening part B2 is connected to a data bus DB, via which a bidirectional communication to other drive rollers or to further units of the logistics system is established. The stand elements S1 and S2 of the support structure are connected to ground.

The fact that the energy line EL and the data bus DB are laid in the profile of the associated support structure S1, S2, respectively facing away from the roller, allows the mechanical operation of the roller R1 not to be impaired by the cabling. Furthermore, this type of cabling makes the lines easily accessible for the service personnel.

In the representation according to FIG. 5 it is shown how the positive mechanical fit between the roller R1 and the stand elements S1 and S2 of the support structure takes place. At the end of the roller R1 there are fastening parts B1 and B2, respectively. The fastening part B1 with a four-cornered profile is represented here by way of example. This four-cornered profile of the fastening part B1 is fitted into the clearance A of the support structure (indicated by stand element S1). The dimensions of the clearance A are determined by the side lengths of the four-cornered profile of the fastening part B1. They must be chosen in such a way that a positive and stable connection is produced between the support structure and the roller. For this purpose, such a close positive fit may be chosen that a press fit is produced. The dead weight of the roller and the described configuration of the connection between the roller and the support structure at at least one end of the roller make it possible for the roller to operate correctly without further retaining or fixing mechanisms.

In the representation according to FIG. 6 it is shown how the energy supply via the energy line EL takes place for the roller R1 via the fastening part B1. In this case, the contact between the energy line EL and the fastening part B1 is established by a penetration clip DC. Via the fastening part B1, the energy feed then takes place into the interior of the roller, to be precise to the electronics module (EM; FIG. 4) and to the motor (M; FIG. 4) the energy feed then takes place into the interior of the roller, to be precise to the electronics module (EM; FIG. 4) and to the motor (M; FIG. 4). The energy line EL and the fastening part B1 are surrounded by an insulating part I on the side of the profile of the support structure S1 that is facing away from the roller R1.

The contacting of the data bus DB with respect to the roller R1 likewise takes place with penetration clips DC, into the corresponding fastening parts B2. With the aid of the penetration clips DC, not only the contacting but also the fastening of the energy line EL and the data bus DB is achieved and ensured.

In the same way, apart from other additional rollers or drive rollers, still further units, such as for example sensors or actuators, can also be connected to the energy line EL and to the data bus DB and integrated in the logistics system. Logistics systems equipped according to the invention can consequently be extended and modified very easily. Disassembly can also be achieved in a very simple and low-cost manner. Once the penetration clips have been removed again, the rollers just have to be lifted out.

Roller, especially for roller conveyors of transport and/or logistics systems, with integrated sensor system. The roller may be formed as a passive roller or as a drive roller. Furthermore, the roller may have an integrated drive and/or integrated information-processing units. The positive fit between the roller and the support structure may take place by means of at least one polygon profile at the end of the roller.

The Contacts

with respect to the lines for the energy supply and the data bus are advantageously established with penetration clips.

1. A roller (R1) for a roller conveyor, especially for transport and/or logistics systems, characterized by an integrated sensor system (SE1, SE2).

2. The roller (R1) as claimed in claim 1, characterized in that the integrated sensor system (SE1, SE2) comprises at least one inductive sensor.

3. The roller (R1) as claimed in claim 1, characterized in that the integrated sensor system (SE1, SE2) comprises at least one capacitive sensor.

4. The roller (R1) as claimed in claim 1, characterized in that the integrated sensor system (SE1, SE2) comprises at least one optical sensor (LLS, D).

5. The roller (R1) as claimed in claim 1, characterized in that the integrated sensor system (SE1, SE2) comprises at least one vibration sensor and/or at least one piezo sensor.

6. The roller (R1) as claimed in claim 1, characterized in that the integrated sensor system (SE1, SE2) comprises at least one microwave transmitter and/or at least one radar transmitter.

7. The roller (R1) as claimed in one of the preceding claims, characterized in that the roller (R1) has an integrated drive (M, G), which can be connected to an electrical energy supply (EL).

8. The roller (R1) as claimed in one of the preceding claims, characterized in that the roller (R1) has an integrated information processing unit (EM) and in that the latter can be connected via a central data bus (DB), which also has connection possibilities for a multiplicity of further units, separate lines being provided for the energy supply (EL) and the data bus (DB).
